(19) United States
(12) Patent Application Publication
(10) Pub. No.: US 2011/0099027 A1
(43) Pub. Date: Apr. 28, 2011

(54) COLLABORATIVE HEALTHCARE

(75) Inventor: R. David Weathers, Tampa, FL (US)

(73) Assignee: VITALZ TECHNOLOGIES, LLC, Tampa, FL (US)

(21) Appl. No.: 12/910,766

(22) Filed: Oct. 22, 2010

Related U.S. Application Data
(60) Provisional application No. 61/254,027, filed on Oct. 22, 2009.

(51) Int. Cl. G06Q 50/00; G06Q 10/00; G06F 21/00

(52) U.S. Cl. 705/2; 726/4

(57) ABSTRACT

A specialty programmed computing system provides a platform for collaboratively providing and consuming healthcare products and services. Modules of the platform and third-party modules (accessing through an API) process and display patient EHR, practice management information, relationship (social network) information, and organizational structure information that is stored within the system and/or in data repositories of member entities in state/regional/national health information exchanges. The patent and/or provider portal is branded for the sponsoring organization, and communication tools and resources are made available to a given user based on their role, affiliation(s), and relationships.

### REFERENCE TO RELATED APPLICATION

This application is a nonprovisional of, and claims priority to, U.S. Provisional Application No. 61/254,027, filed Oct. 22, 2009, with title “Collaborative Healthcare,” pending. The entire disclosure in that application is incorporated herein by reference as if fully set forth.

### FIELD

The present invention relates to data processing of financial, business practice, management or cost/price determination. More specifically, the present invention relates to automated electrical financial or business practice or management arrangements in the field of healthcare management.

### BRIEF DESCRIPTION OF THE DRAWINGS

FIG. 1 is a block diagram of a computing system adapted for collaborative healthcare according to one embodiment.

FIG. 2 is a schematic diagram of a computer for use in the embodiment of FIG. 1.

FIG. 3 is a schematic diagram of a data system implementing an embodiment of FIG. 1.

FIG. 4 is a schematic diagram of a social networking computing system according to a second embodiment of the present invention.

### DESCRIPTION

For the purpose of promoting an understanding of the principles of the present invention, reference will now be made to the embodiment illustrated in the drawings and specific language will be used to describe the same. It will, nevertheless, be understood that no limitation of the scope of the invention is thereby intended; any alterations and further modifications of the described or illustrated embodiments, and any further applications of the principles of the invention as illustrated therein are contemplated as would normally occur to one skilled in the art to which the invention relates.

Generally, one form of the present system is a healthcare collaboration computing platform with several features for the collaborative provision and consumption of healthcare-related services, products, and information. Participants in the healthcare industry can use the system to establish and maintain relational groups; provide healthcare services; distribute, maintain, and share general educational, pharmaceutical, and product information; create, manage, and maintain personal health information; conduct research, collect market data, and provide customer service; and engage in other activities as will occur to those skilled in the relevant technology. Participants in all roles leverage the front-end and back-end tools in this platform to facilitate education, controlled information dissemination and sharing, personal health record (PHR), and electronic health record (EHR) information, and delivery of efficient healthcare solutions.

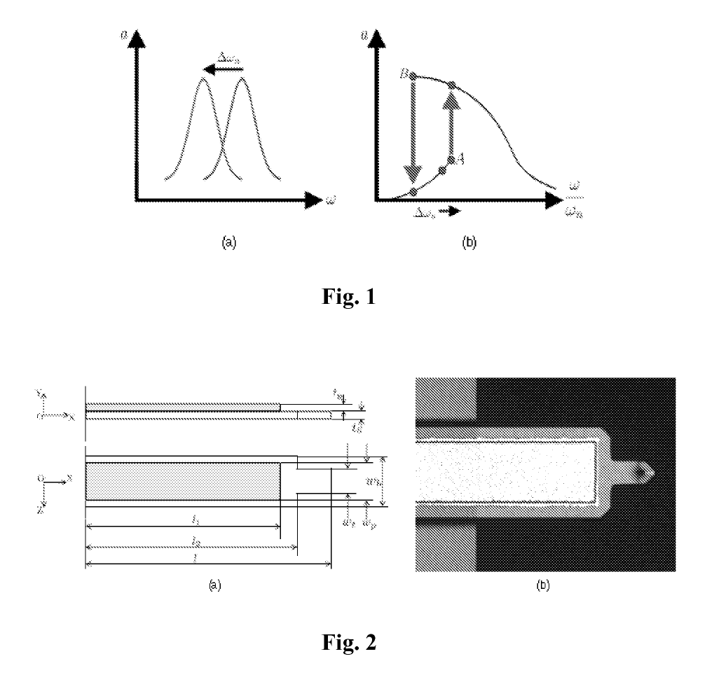

FIG. 1 illustrates the various participants in system 100, all connected via collaboration platform 110. Patients 120, doctors 130, and hospital personnel 140, each have data connections, either intermittent or permanent, to collaboration platform 110. Some doctors 130 have direct connections to hospitals 140 built on traditional electronic medical records (EMR) systems, and these systems might connect directly or indirectly to collaboration platform 110 as well. In various plans, other participants include insurance provider 135, patients' family members 150, researchers 160, pharmaceutical manufacturers 170, publishers 180, and application developers and providers 190.

The computers used as servers, clients, resources, interface components, and the like for the various embodiments described herein generally take the form shown in FIG. 2. Computer 200, as this example will generically be referred to, includes processor 210 in communication with memory 220, output interface 230, input interface 240, and network interface 250. Power, ground, clock, and other signals and circuitry are omitted for clarity, but will be understood and easily implemented by those skilled in the art.

With continuing reference to FIG. 2, network interface 250 in this embodiment connects computer 200 a data network (such as a direct or indirect connection to Collaboration Platform 110) for communication of data between computer 200 and other devices attached to the network. Input interface 240 manages communication between processor 210 and one or more pushbuttons, UARTs, IR and/or RF receivers or transceivers, decoders, or other devices, as well as traditional keyboard and mouse devices. Output interface 230 provides a video signal to display 260, and may provide signals to one or more additional output devices such as LEDs, LCDs, or audio output devices, or a combination of these and other output devices and techniques as will occur to those skilled in the art.

Processor 210 in some embodiments is a microcontroller or general purpose microprocessor that reads its program from memory 220. Processor 210 may be comprised of one or more components configured as a single unit. Alternatively, when of a multi-component form, processor 210 may have one or more components located remotely relative to the others. One or more components of processor 210 may be of the electronic variety including digital circuitry, analog circuitry, or both. In one embodiment, processor 210 is of a conventional, integrated circuit microprocessor arrangement, such as one or more CORE 2 QUAD processors from INTEL Corporation of 2200 Mission College Boulevard, Santa Clara, Calif. 95052, USA, or ATHLON or PHENOM processors from Advanced Micro Devices, One AMD Place, Sunnyvale, Calif. 94088, USA, or POWER6 processors from IBM Corporation, 1 New Orchard Road, Armonk, N.Y. 10504, USA. In alternative embodiments, one or more application-specific integrated circuits (ASICs), reduced instruction-set computing (RISC) processors, general-purpose microprocessors, programmable logic arrays, or other devices may be used alone or in combination as will occur to those skilled in the art.

Likewise, memory 220 in various embodiments includes one or more types such as solid-state electronic memory, magnetic memory, or optical memory, just to name a few. By way of non-limiting example, memory 220 can include solid-state electronic Random Access Memory (RAM), Sequentially Accessible Memory (SAM) (such as the First-In, First-Out (FIFO) variety or the Last-In First-Out (LIFO) variety), Programmable Read-Only Memory (PROM), Electrically Programmable Read-Only Memory (EPROM), or Electrically Erasable Programmable Read-Only Memory (EEPROM); an optical disc memory (such as a recordable, rewritable, or read-only DVD or CD-ROM); a magnetically encoded hard drive, floppy disk, tape, or cartridge medium; or a plurality and/or combination of these memory types. Also, memory 220 is volatile, nonvolatile, or a hybrid combination of volatile and nonvolatile varieties.

One aspect of the system leverages an integrated social networking platform to facilitate information exchange and other functions. For example, as in other social networking systems, users in all roles can indicate existing relationships and establish new relationships through the system. Participants can use existing relationships, search functions, and referrals from friends to build a network of new resources and community, which they can then leverage for further referrals, recommendations, and support. Similarly, physicians can manage and expand their networks of information resources, referral networks, and professional relationships using analogous social networking techniques and facilities made available through the system. The system facilitates development and maintenance of these relationships by streamlining text, voice, and or video chat and conferencing, reminders, event announcements, calendar management and sharing, and other interaction types that will occur to those skilled in the art.

In addition, however, to the traditional modes of operation of purely social “social networks,” the present system includes features that provide exceptional advantages to the health care community. For example, the payment system mentioned above is simplified and facilitated by the networking, authentication, and privacy mechanisms in this system. The system's standardized (i.e., common) interface facilitates the fielding of questions about billing procedures, processes, and status inquiries by patient-payors, TPPs, insurance companies, and the like. Referrals are facilitated by connections that can be made as easily as a drag-and-drop gesture in the user interface. Similarly, favorite or frequently referred-to information resources are customized and presented to each individual user in easily accessible links or graphical user interface (GUI) objects.

This social networking subsystem also facilitates handling of prescriptions in new and interesting ways. For example, the physician may use his or her office system 330 during an office visit to write a prescription. The personal health characteristics and lists of other medications taken by patient 120 would already be stored in and available through the system 310 and could be used to check for drug interactions, provide dosing advice, and even suggest side effect warnings and scripts for physicians to consider using during their consultation with patients 120.

When the physician 130 has decided to write a prescription, he or she submits the prescription via his or her office system 330 and collaboration system 310 to the pharmacy 375 of choice for patient 120. Insurance information for patient 120 may be delivered at the same time, and a confirmation via facsimile may be sent to the pharmacy 175 simultaneously. In various situations or embodiments, pharmacy 175 may fill the prescription as soon as possible or wait until patient 120 is present to begin the process, depending either on policy, preference, or instructions from patient 120 or physician 130 as part of the prescription submission.

Renewals and refills are also submitted through the system. When patient 120 needs or wants to refill a prescription that had been processed through system 310, they can use patient terminal 320 to identify the prescription and medication to be refilled, the pharmacy by which it had been filled, and the cost and payment information related to that previous transaction. Using the unified interface of system 310, patient 120 initiates the refill of the prescription, provides any necessary information updates, and answers any insurance questions. If patient 120 is away from home, system 310 can be used to find other stores in the same pharmacy chain, and can even find unaffiliated pharmacies that also participate in the network and are close to the current location of patient 120. In some embodiments, the insurance providers through whom each pharmacy is willing to submit claims and/or receive payment are accessible through the system 310, so the reporting and/or referral process for each particular transaction can be up-to-date and appropriately focused. In some embodiments, the current stock of pharmaceuticals that is available at each pharmacy can be taken into account, too, so delays and wasted trips to the pharmacy can be avoided.

The personal health record (PHR) system integrated within system 310 provides cross-reference to data and validation as to the status and activities of each participant. Activity data, PHR, and access are tracked so that a complete audit log is available to patients (and other participants in the system, though their access may be more limited and/or different). Different participants have rights only to view, to view and modify, to manage (as a “custodian”), or to own particular elements of data performance information. Emergency access is provided to authorized personnel in some embodiments, and such access is tracked for audit and accountability purposes. Emergency and critical-care situations may be informed by previously entered preferences of patient 120, including advance directives and organ donation preferences. Healthcare proxies and powers of attorney may be entered into and accessible through the system as well.

Still further functionality provided by the system includes an online bill payment subsystem, delivery of clinical results (with convenient links to professionals for consultation, additional information, maintenance, and sharing), preregistration for procedures and hospital visits, calculators for health data and various indices, cost estimation based on actual transaction information, delivery of information via podcasts and other RSS feeds and preferred communication channels for patient's practitioners, and other participants in system 310. The system also preferably provides a “dashboard” that presents up-to-date summary information and action items for the patient or professional, reminders, appointment scheduling, time projections, and the like.

Another valuable aspect of system 310 is the exposure of an application programming interface (API) by third parties, with permission of patient 120 and/or other relevant participants, can access data and provide additional information and/or applications that are integrated with system 310. For example, an application developer/provider 190 might develop and application that helps patients with diabetes track their blood sugar. Reminders could be presented on the dashboard mentioned above, and the results of tracking could be presented through the same interface. Access to the results could automatically be provided to family members 150 and/or physicians 130 on a regular or constant basis, or could be accessed on-demand during an online or in-person consultation with a healthcare professional. The same authentication techniques, access controls, and other system resources are available to the application as will occur to those skilled in the art.

Applications of this sort may be monetized through this system as well. In some embodiments, patients 120 might pay for application access (as well as other healthcare-related bills) through system 310, and third parties might pay for applications in other embodiments. For example, insurance companies 135, family members 150, and researchers 160, or even advertisers or employers (not shown) can fund access to applications in various embodiments of system 310.

Another advantageous application of system 310 operates for the benefit of researchers 160. System 310 stores a great deal of data about a great number of individuals, and it includes facilities for anonymizing data (so individual patients cannot be identified, yet data can be tracked longitudinally) and/or consolidation (so that no individual is identifiable within a group). These facilities protect the privacy of the individual patients 120 who might participate in a research study, yet provide the researcher the relevant information for promoting scientific progress.

The combination of a social network with healthcare-rated participants, authentication, encryption, access control, an API and the other systems, subsystems, and resources discussed herein will be applied to great advantage in a wide variety of contexts and applications. In view of this disclosure, those skilled in the art will appreciate many of the various and powerful applications to which this combination can be put.

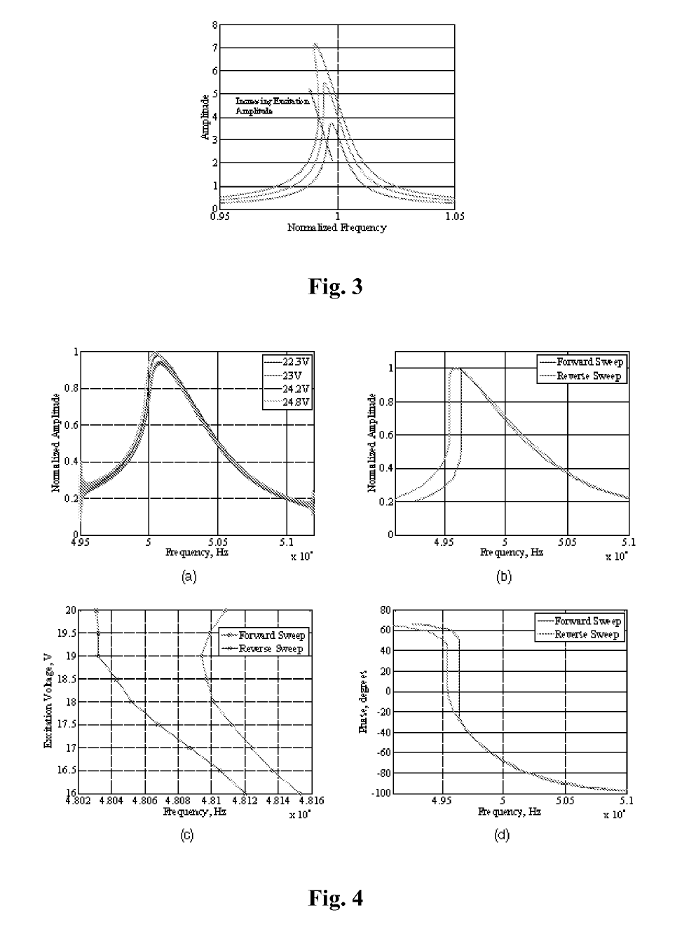

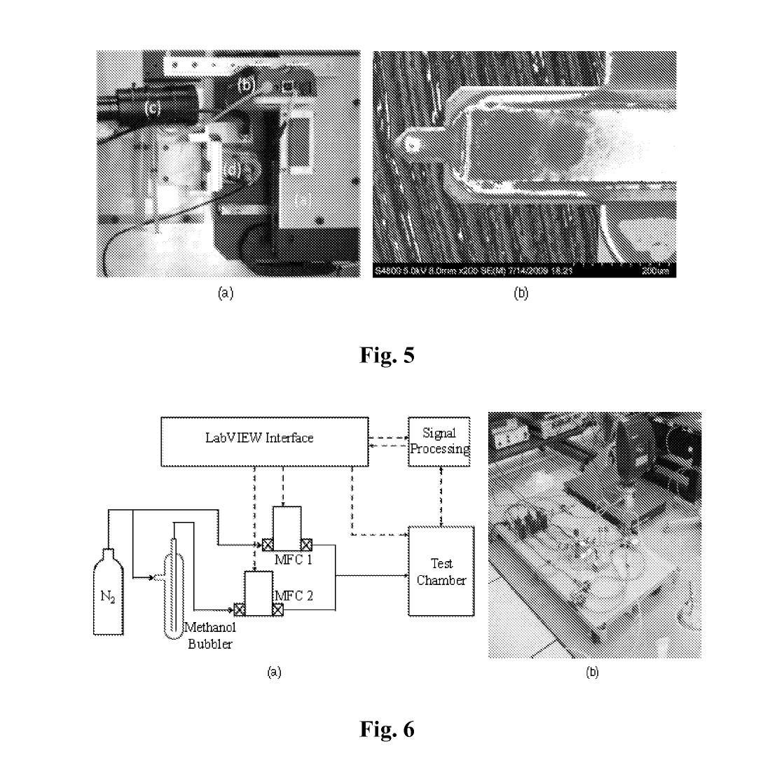

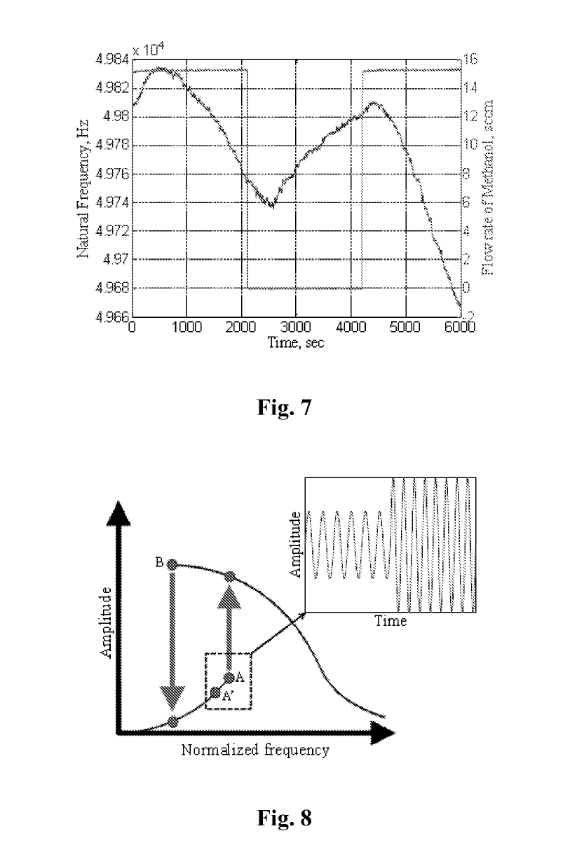

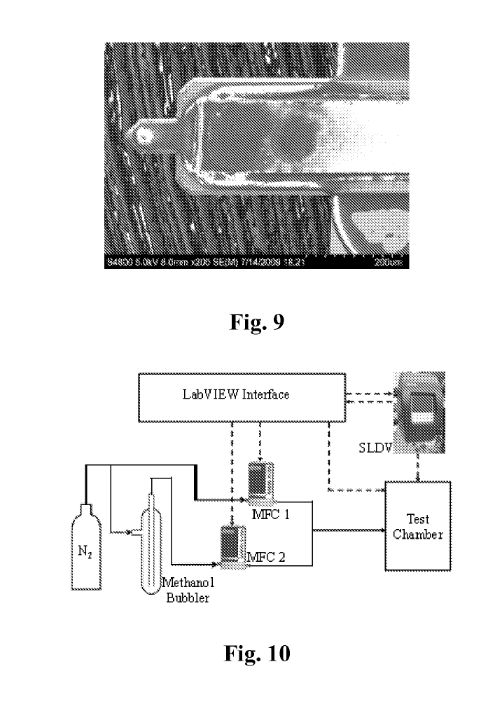

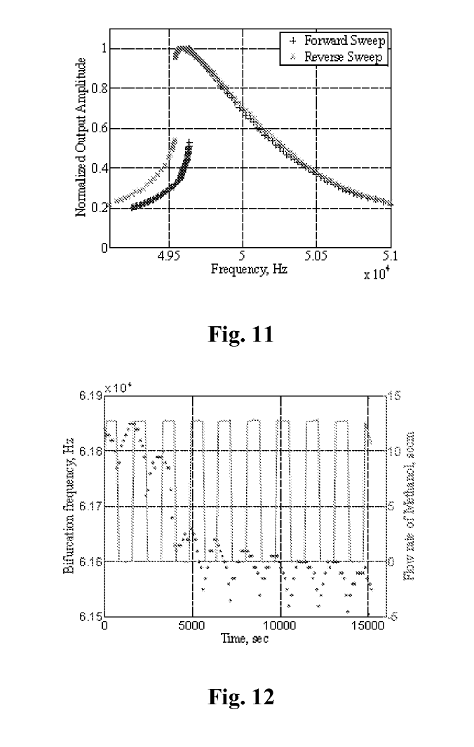

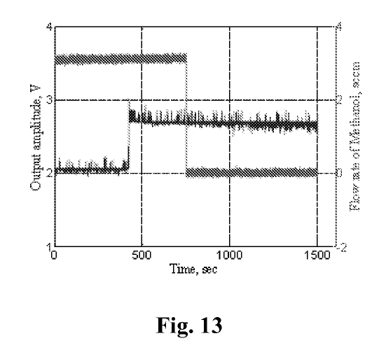

One embodiment of system 310 is illustrated as electronic health records (EHR) system 400 in FIG. 4. In this embodiment, central data repository 410 offers storage for all activities of the system. For example, patient health record (PHR) system 420 maintains patient information in central data repository 410, including but not limited to identity and biographical information, financial information, healthcare-related event records, test results, billing and payment account information, provider relationship and history information, and the like. Some of this information will be entered by a patient, while other data will be uploaded by the patient or on his or her behalf in a computer-readable form.

Similarly, electronic health record (EHR) system 430 stores health records, such as physician notes, test or lab results, health history and diagnosis information, and the like in central data repository 410. This data is uploaded by physicians' staff, hospital records personnel, and other medical personnel to document interactions with the patient, test results, health history, diagnoses, and the like as are understood by those skilled in the art. Like PHR data from PHR system 420, EHR data is transferred to central data repository 410 in computer-readable form and associated with a particular patient for retrieval and use as discussed herein and as will occur to those skilled in the art in view of the present disclosure.

Social networking system 440 is another module of electronic health records (EHR) system 400. The social networking system 440 manages data regarding relationships between patients and providers, facilitates referrals and other introductions, maintaining a relationship graph in central data repository 410 that characterizes the caretaker relationships between patients and their providers (at the individual/physician and/or organizational level).

Content management system (CMS) 450 manages the themeing and display of information from the system through presentation layer 600 as will occur to those skilled in the art. CMS subsystem 450 draws information from central data repository for this display, both the content for the particular user accessing the system, as well as brand/theme information, which CMS system 450 uses to present logos, color schemes, and the like. CMS system 450 also customizes the user experience by adapting the options presented according to the type of user, his or her subscription status, practice network affiliation, TPP relationships, and other user data as will occur to those skilled in the art.

Presentation layer 600 includes a patient portal 610 and a provider portal 620. These two interfaces provide the presentation layer 600 of EHR system 400 for access by individuals (on their own behalf and on behalf of entities for whom they work) using work station 650. This entry point is customized for the particular user, who is identified using authentication credentials as will occur to those skilled in the art. All appropriate data and data manipulation options are presented in this embodiment through a single interface (access via presentation layer 600). In alternative embodiments, different functions or modes of operation are characterized by different interface features so that users can easily tell what part of the system they are accessing and how.

Portal management system 460 manages the user's relationship with system 400 itself and the provider thereof. For example, portal management system 460 in some embodiments manages subscription status between the user and the provider of EHR system 400 manages authentication credentials and the authentication process. In other embodiments, portal management system 460 enables provider users of the system to control and manage the look and feel, the navigation, and the core functionality available to other public users of the system. In this way, the system is capable of supporting multiple host providers of the system that can configure and manage the functionality available to their customers.

Messaging engine module 470 manages the significant function of handling secure messaging among participants in EHR system 400. For example, in some embodiments, patients are notified via messaging engine 470 that additional information has been added to central data repository 410 in connection with their personal EHR. Appointments with particular practitioners or practices are confirmed via messaging engine 470, and follow-up messages from practitioners to patients are automatically sent as a function of appropriate business rules and events in the patient's healthcare-related life. Messaging engine 470 maintains security of messages in compliance with applicable regulations and maintains an audit trail of all messaging access.

User/organizational management system 480 manages information regarding the configuration of organizational structures. For example, user/organization management system 480 in the present embodiment contains information about users who are practitioners and the entities with which they are affiliated. A doctor, for example, may be affiliated with a physician practice group, having admitting privileges at a hospital, and be an educator in a university. That physician might then have access to the system 400 would then have access to scheduling information for his or her physician group, resource availability for the hospital, and experimental data from the laboratory. He or she would get secure messages through messaging engine 470 regarding appointment changes for the practice group, patient status updates for his or her patients who have been admitted to the hospital, and research updates at the lab. The underlying EHR system that the organizations have in common enables the practitioner to use a single messaging system 470 that is integrated with user/organization management system 480 with access to the data from central data repository 410 to efficiently manage information about his or her practice and patients to an extent that cannot presently be achieved in the marketplace.

Custom module engine 490 provides a platform (i.e., an application programming interface, or API) with which third parties can develop additional functionality for EHR system 400. Using this custom module engine 490, third party software might, for example, add additional network discovery functionality, TPP interfaces, additional reporting capabilities, and other facilities and resources as will occur to those skilled in the art in view of the present disclosure. Thus, EHR system 400 is extensible, yet can be managed to be compliant with even the strictest privacy and security requirements by combination of the various items of information from central data repository 410.

Single sign-on module 510 enables users of EHR system 400 to authenticate a single time with EHR system 400 and leverage that authentication transaction into authentication with other systems that hold relevant data for the user's desired uses and transactions. This single sign-on module 510 in some embodiments is a custom-developed software module, while in other embodiments it is an off-the-shelf module.

Custom form engine 520 enables users to design a custom form, which can be presented to other user of EHR system 400. For example, a physician practice group might request registration information online through this custom module in lieu of on-site customer registration. Other forms will occur to those skilled in the art and to users as they become accustomed to the resource. Data from custom forms developed in custom form engine 520 is retrieved and used to generate custom reports using custom report engine 530.

Standard vocabulary engine 540 provides a resource to all the other modules and components in the EHR system 400 so that medical terminology can be converted, indexed and searched efficiently across all parts of the platform Like other components in the system, standard vocabulary engine 540 is custom-developed in some embodiments, which in others it is a standard, off-the-shelf module.

Master patient index 550 coordinates data from all sources (discussed elsewhere herein) to integrate all data for each particular patient into a single record. This provides users an integrated medical record, solving the problem of fragmentation of patent records across the systems of many providers.

Data warehousing and reporting engine 560 maintains the overall integrity of the database. It also provides low-level reporting resources for use by other modules in the EHR system 400 as it will occur to those skilled in the art.

Chronic disease management rules engine 570 draws patient data from central data repository 410 and applies a rules engine to guide and monitor chronic disease management, detect changes in the patient's condition and keep practitioners apprised of changes in their patient's conditions. Standard-based interoperability engine 700 serves as a data connector between EHR system 400 and external data sources, such as provider and government health record systems. Portal aggregation data exchange component 720 provides interface service with respect to one or more external, portal-based systems, exchanging information through that portal to complement the electronic held records in central data repository 410. Similarly, enterprise data exchange connector 740 provides a data interface/connector with enterprise EHR systems, such as physician office management systems, hospital record systems, and the like. In some embodiments, legacy enterprise systems that are generally replaced by EHR system 400 maintain their data and, at least during adoption of the system. In other embodiments, individual physician offices maintain their own systems and merely exchange data with EHR system 400.

Other components of inoperability engine 700 serve as one- or two-way connectors with other data sources and syncs, such as state/regional health information organizations and exchanges served by state/regional (RHIO/HIE) data exchange 760 and national NHIN data exchange 780. Still other data sources may be served by these and other data connectors as will occur to those skilled in the art in view of the present disclosure. Some exchanges in some embodiments operate at user interface level, while others use program-managed access methods (APIs), and some push and pull data at the record level to transport it in and out as needed to serve patients and other users of the system 400. Either or both of these methods may be supported by the system.

Provider portal 620 is a workflow management tool for operational users in the provider arena. This module provides the user a summary of all tasks necessary to manage incoming requests and provides tools to manage communications and patient care. Provider portal 620 uses data from various sources, including but not limited to messaging engine 470, user/organization management system 480, and defined workflows (implemented in this embodiment in data warehousing and reporting engine 560) to manage secure communications between the provider and patients, colleagues, vendors, third-party payors, and other parties. These messages are secure and compliant with health information privacy acts.

Provider-to-provider messaging allows for collaboration between two organizations in the system regardless of whether the organizations are parts of the same parent organization. Patient referrals and general inquiries may be exchanged using this messaging system. The system in some embodiments is also used to enable a desired level of portability of information, care, and coverage.

A patient-to-provider component of the messaging system facilitates efficient, secured communication of health request between a practice and its patient community. For example, patients can request new appointments, reschedule existing appointments, and cancel appoints; request test results, request new or duplicate invoices; request prescriptions; and request estimates for procedures. In some embodiments, an open “provider search” facility is available for patients desiring care, and in some embodiments patients can request referrals from their primary care providers. In each instance, messages that need to be seen and/or processed by the provider are available through provider portal 620.

The patient portal 610 is the primary workflow management tool in this embodiment for patient management of transaction requests across providers who are reachable through the network. Patient portal 610 shows message summaries for the patient, health-related reminders, and interface components that the patient can use to initiate and monitor healthcare-related transactions.

Patient portal 610 enables patients to securely collaborate with their providers. Messages can be initiated by patients at their convenience with security of the information being assured, and message replies are guaranteed within defined time frames. Again, all patient messages are secure and compliant with health information privacy regulations.

In various embodiments, patient-to-provider messaging allows for efficient, secure communication of health requests between a patient and their health care providers.

As those skilled in the art will understand, many (if not all) messages, transactions, and transfers of information are documented in the system. In some embodiments, for example, an audit trail persistently records each authorization by a patient for another party to receive any health-related information. In others, audit records reflect the identity of the individual employee of a pharmacy, for example, who authorizes dispensing of a medication.

All publications, prior applications, and other documents cited herein are hereby incorporated by reference in their entirety as if each had been individually incorporated by reference and fully set forth. While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. A system for managing health information, comprising a processor and a memory in communication with the processor, the memory storing programming instructions executable by the processor to:
maintain an index of patients;
manage a first database of health information about the patients in a first data format;
enable read-write access to a separate database of health information about at least one of the patients, where the separate database is in a second data format, by implementing a bidirectional mapping between the first data format and the second data format; and
as a function of business rules, health information from the first database, and health information in the separate database, automatically creating a secure electronic message accessible only to a specific authenticated user of the system.

2. The system of claim 0, wherein the automatically created message is triggered by a real-life event related to the authenticated user.

3. The system of claim 2, wherein the event is reflected in a change in the data in the first database.

4. The system of claim 0, wherein the automatically created message is triggered by command of a different authenticated user of the system.

5. The system of claim 0, wherein:
the authenticated user is a patient; and
the content of the automatically created message is post-consultation follow-up instructions for the user.

6. A system for managing health information, comprising a processor and a memory, the memory being encoded with programming instructions executable by the processor to display a user interface that:
authenticates a user;
once a user is authenticated, accepts input from the user; and
interprets the input to control access across computing systems of multiple providers, which includes controlling the flow of data to or from the providers' systems;
wherein the providers' systems do not natively exchange data with each other.

7. The system of claim 6, wherein at least one of the providers is a physician.

8. The system of claim 6, wherein at least one of the providers is a hospital.

9. The system of claim 6, wherein at least one of the providers is a dentist.

10. A system for managing health information, comprising a processor and a memory in communication with the processor, the memory storing programming instructions executable by the processor to:
maintain a database of patient health data and patient-provider relationships;
provide a computing facility for a third party to implement an extension to the systems, wherein the extension accesses the patient health data and patient-provider relationship data;
wherein the access provided to the extension is limited as a function of patient permission data in the database.

11. The system of claim 10, wherein the access provided to the extension is further limited as a function of patient-provider relationship data in the database.

12. The system of claim 10, wherein the access provided to the extension is further limited as a function of provider affiliation data in the database.
